(19) United States
(12) Patent Application Publication
(10) Pub. No.: US 2013/0335567 A1
(43) Pub. Date: Dec. 19, 2013

(54) VEHICLE EVENT DATA RECORDER SET CAPABLE OF RETAINING A HANDSET

(71) Applicant: Wen Chuan Wang, Taoyuan (TW)

(72) Inventor: Wen Chuan Wang, Taoyuan (TW)

(21) Appl. No.: 13/525,382

(22) Filed: Jun. 18, 2012

(51) Int. Cl. H04N 7/18

(52) U.S. Cl. 348/148; 348/E07.085

(57) ABSTRACT

A vehicle event data recorder set capable of retaining a handset; comprises a main body of a vehicle event data recorder; the main body including a processor; the main body being installed with: a display screen at a front side of the main body; a handset retaining seat extending from the main body for locating a handset. The main body includes: a camera for capturing images out of a windscreen of a car; the images captured by the camera being transferred to the processor; a fixing unit for fixing the main body to a specific object having a connecting rod and a disk connected to the connecting rod; the disk being sucked to a windscreen of a car; a G-sensor connected to the processor and for detecting the accelerations in different three dimensions; and a WiFi system for inducing communication between a handset and the main body.

### FIELD OF THE INVENTION

The present invention relates to car used event data recorder, and particularly to a vehicle event data recorder set capable of retaining a handset.

### BACKGROUND OF THE INVENTION

Conventionally, a vehicle event data recorder serves to capture images in driving. Other than image capturing, the conventional event data recorder has no other function. However currently, handset is a frequently used electronic device, which is carried almost all times. However generally, a car has no specific position for locating a handset. This is inconvenient for drivers.

Most of current intellectual handsets can download GPS software to have the function of positioning, while an event data recorder can record images in driving. Thus an event data recorder and a handset can be combined to present various usages to provide many newly functions to users. However currently, the even data recorder is independent from the handset within a car. The function of the even data recorder can not combine with the handset.

Therefore, the object of the present invention is to provide a structure which can combine the event data recorder with a handset so as to provide many newly functions to users.

### SUMMARY OF THE INVENTION

Accordingly, the primary object of the present invention is to provide a vehicle event data recorder set capable of retaining a handset, wherein the car event data recorder is combined with a handset. The data therebetween is transferred by using a WiFi system. The MP3 data in the handset can be transferred to the event data recorder and then to the car stereo for playing. In the present invention, the handset retaining seat serves to locate a handset and a WiFi system serves to communicate data between the handset and the event data recorder so that the functions of the handset and the event data recorder can be combined. The GPS data can record the positioning data so that the present invention can record the trace, positioning, related images and speeds of the car and these data can be stored in an SD card so that the driving data can be recorded completely.

To achieve above object, the present invention provides a A vehicle event data recorder set capable of retaining a handset; comprises a main body of a vehicle event data recorder; the main body including a processor; the main body being installed with: a display screen at a front side of the main body; a handset retaining seat extending from the main body for locating a handset. The main body includes: a camera for capturing images out of a windscreen of a car; the images captured by the camera being transferred to the processor; a fixing unit for fixing the main body to a specific object having a connecting rod and a disk connected to the connecting rod; the disk being sucked to a windscreen of a car; a G-sensor connected to the processor and for detecting the accelerations in different three dimensions; and a WiFi system for inducing communication between a handset and the main body.

The various objects and advantages of the present invention will be more readily understood from the following detailed description when read in conjunction with the appended drawing.

### BRIEF DESCRIPTION OF THE DRAWINGS

FIG. 1A is a schematic view of the present invention.

FIG. 1B is a rear view of the present invention.

FIG. 1C shows the application of the present invention with a camera.

FIG. 1D is a left side view of the present invention.

FIG. 2A shows the application of the present invention.

FIG. 2B is a right side view of the present invention.

FIG. 3 is a schematic view showing the elements of the present invention.

FIG. 4 is a right side view showing that the present invention is combined with other device.

FIG. 5 is a schematic view showing the application of the present invention with a WiFi system.

FIG. 6 is a schematic view showing that the present invention is used with GPS system.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

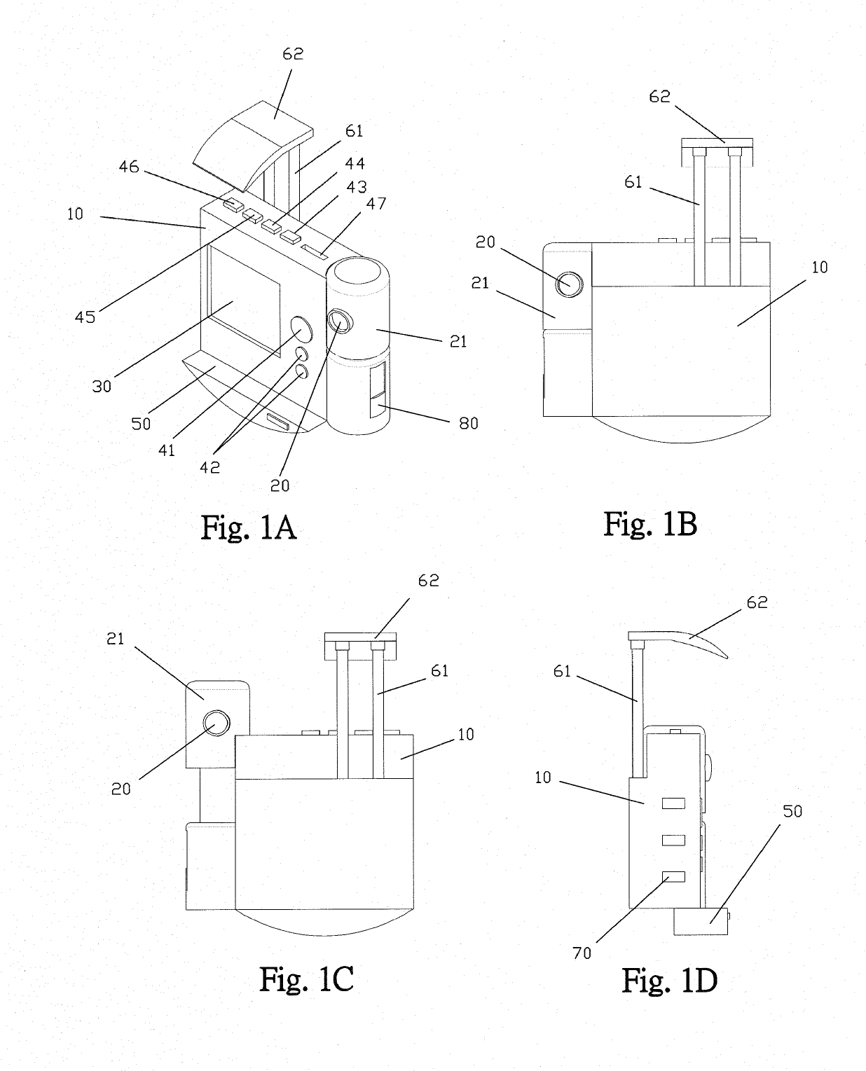

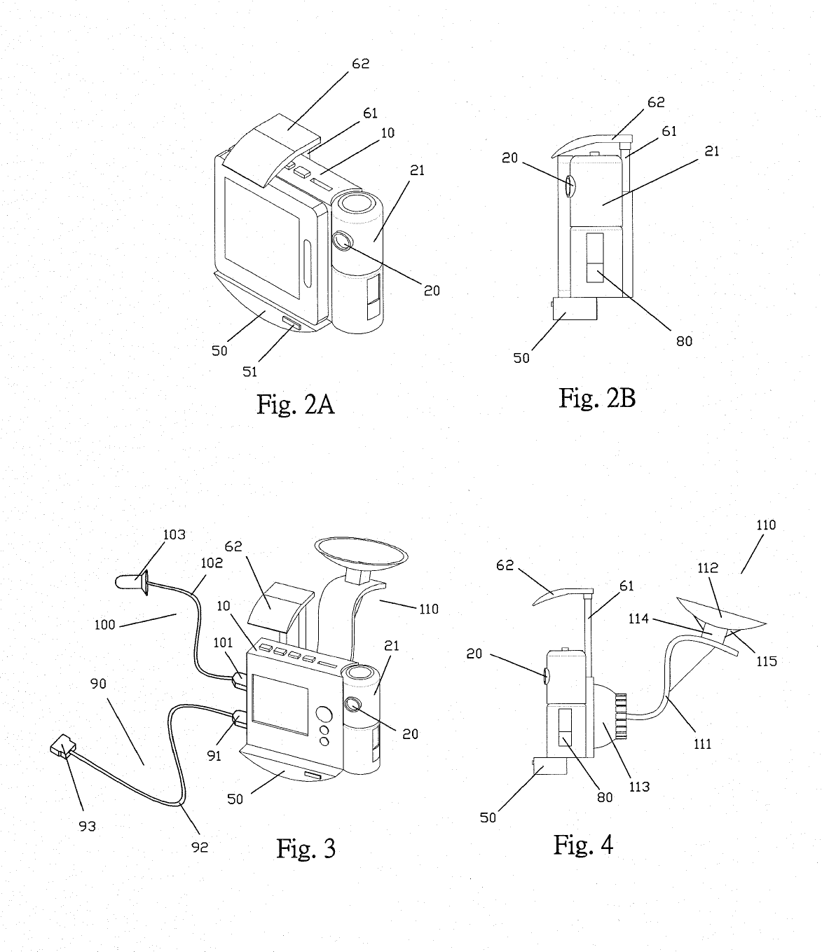

Referring to FIGS. 1A to 1D and 2A to 2B, the present invention is related to a driving event data recorder with a handset. The structure of the present invention includes the following elements:

A main body 10 of a vehicle event data recorder has an approximately rectangular shape with function elements. The main body 10 includes a processor 11.

An outside of the main body 10 of the vehicle event data recorder has the following elements.

A camera 20 is located on a round cylinder 21 which is located at a lateral side of the main body 10 and has the same elevation as that of main body 10. The camera 20 serves to captures images out of a windscreen of a car. The images captured by the camera 20 are transferred to the processor 11. The round cylinder 21 is rotatable through 180 degrees and has a fine adjusting button 80 for adjusting a height of the camera 20 as illustrated in FIGS. 1A, 1B and 1C.

A display screen 30 is at a front side of the main body 10 for displaying images from the processor 11 (such as the driving event data captured by the camera 20). Preferably, the display screen 30 has an LED screen with a size of 2.2 inches.

A plurality of function keys are located at a front panel and upper panel of the main body 10 and are connected to the processor 11. With reference to FIG. 1, the function keys includes an enter key 41, an up and down key 2, a menu key 43, a switch key 44, a mode selection key 45 and a RESET key 46.

A handset retaining seat 50 extends from a lower side of the main body 10 for locating a handset. The handset retaining seat 50 includes a power indicator 51 as shown in FIG. 2A.

A telescopic handset retaining frame 60 is positioned at an upper side of the main body 10. The telescopic handset retaining frame 60 has two supporting rods 61 and a retaining block 62 supported by the two supporting rods 61. A height of the two supporting rods 61 are adjustable. When a handset is placed upon the handset retaining seat 50, the height of the retaining block 62 is adjusted to exactly clamp the handset without vibration or falling out as illustrated in FIG. 2B.

As illustrated in FIG. 1D, the present invention further includes a slot set 70 at a left side of the main body 10. The slot set 70 includes an ear slot 71, a plurality of USB slots 72 and a HDMI slot 73 for connecting to the display screen.

An SD slot 47 is at an upper side of the main body 10 for receiving an SD card for storing the images from the camera 20.

With reference to FIGS. 3 and 4, the present invention further includes:

A USB handset power charger 90 includes a charger USB plug 91, an electric wire 92 and a handset USB plug 93. When the charger USB plug 91 is inserted into the USB slot 72 and the handset USB plug 93 is connected to the handset on the handset retaining seat 50, the handset will be charged. The electric wire 92 is a telescopic wire for connecting the USB handset power charger to the handset not locating on the handset retaining seat 50

A car MP3 communication unit 100 includes a device end USB plug 101, an MP3 wire 102, and a car-end plug 103. The device end USB plug 101 can be connected to the USB slot 72. The car-end plug 103 is connected to the ignition plug of a car so that the MP3 signals are transferred to a car stereo through the car-end plug 103. Thus the MP3 signals can be emitted from a car trumpet by a built-in FM emitter of the car stereo. The mode selection key 45 is used to select the songs t be emitted.

A fixing unit 110 has a connecting rod 111 and a disk 112 connected to the connecting rod 111. The disk can be sucked to a windscreen of a car. A backside of the main body 10 has a convex portion 113 connected to the connecting rod 111. An upper side of the connecting rod 111 has an adjusting shaft 114 and a supporting frame 115. The adjusting shaft 114 serves to adjust the orientation of the disk 112 so that the main body 10 can be absorbed to the windscreen. The supporting frame 115 extends from the connecting rod 111 to the disk 112 for retaining the disk 112, as illustrated in FIG. 4.

The main body 10 includes the following elements.

A G-sensor 119 is connected to the processor 11 and can detect the accelerations in different three dimensions. The G-sensor 119 always acts even the main body 10 is deactivated. The G-sensor 119 can instruct the processor 11 to record the data in the SD card before and after a specific event in a memory, the specific event is such as a strong impact (for example, an impact of 10 G) to the car having the main body 10 of the present invention so that these data will not disappear due to other new recording data. Once a strong impact is detected by the G-sensor 119, the G-sensor 119 will drive the main body 10 and the processor 11 and cause the camera 20 to capture image and record the images.

A WiFi system 120 serves to induce communication between a handset and the main body 10. When the handset is placed on the handset retaining seat 50, the image of the driving even data recorder can be viewed by users. The MP3 data of a handset can be transferred to the main body 10 through the WiFi system 120. Then the MP3 power supply 100 can transfer the MP3 data to a car stereo for playing as illustrated in FIG. 5.

The WiFi system includes a WiFi-SOS device 121 for finding a wireless base station so to as transfer the data of SD card in the main body 10 wirelessly to other servos (such as a cloud servo, face book, etc.). After uploading of the data, these data are removed from the SD card so as to retain the old data without disappearance.

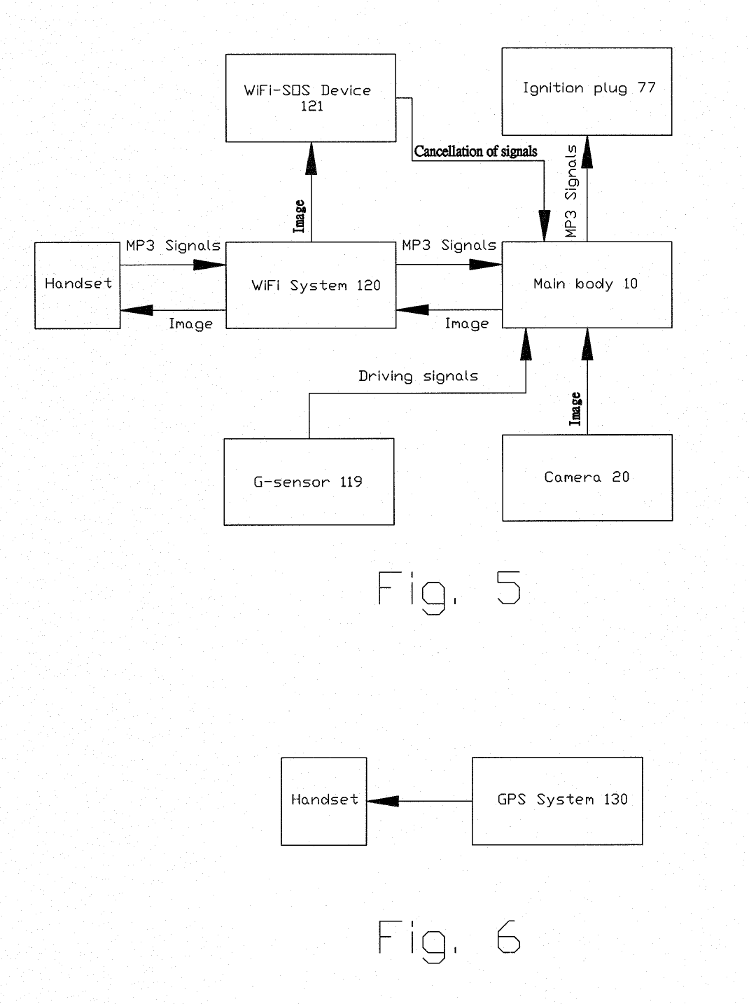

A GPS positioning system 130 serves for getting a position of the main body 10. The position can be transferred to a map in a handset through the WiFi system 120 so as to be combined to the map and then the combine data is displayed on a screen of the handset. The GPS positioning system 130 is built with trace recorder for recording the traces of the main body 10 (and thus the traces of a car owning the main body 10 are recorded). Other passengers in the car can have the traces by finding the same frequency bands of the WiFi system 120. The positioning data and traces can be uploaded by handset network connection so as to record the data forever as illustrated in FIGS. 5 and 6.

In the present invention, the car event data recorder is combined with a handset. The data therebetween is transferred by WiFi system. The MP3 data in the handset can be transferred to the event data recorder. The device end USB plug 101 can be connected to the USB slot 72. The ignition plug 103 is connected to the ignition plug of a car so that the MP3 signals are transferred to a car stereo through the car-end plug 103. Thus the MP3 signals can be emitted from a car trumpet by a built-in FM emitter of the car stereo. The mode selection key 45 is used to select the songs to be emitted. In the present invention, the handset retaining seat serves to locate a handset and a WiFi system serves to communicate data between the handset and the event data recorder so that the functions of the handset and the event data recorder can be combined. The GPS data can record the positioning data so that the present invention can record the trace, positioning, related images and speeds of the car and these data can be stored in an SD card so that the driving data can be recorded completely. Furthermore, the USB handset power charger 90 serves to charge the handset despite the position of the handset.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vehicle event data recorder set capable of retaining a handset; comprising:
a main body of a vehicle event data recorder; the main body including a processor;
the main body being installed with:
a display screen at a front side of the main body;
a handset retaining seat extending from the main body for locating a handset;
the main body including:
a camera for capturing images out of a windscreen of a car; the images captured by the camera being transferred to the processor;
a fixing unit for fixing the main body to a specific object having a connecting rod and a disk connected to the connecting rod; the disk being sucked to a windscreen of a car;
a G-sensor connected to the processor and for detecting the accelerations in different three dimensions; and
a WiFi system for inducing communication between a handset and the main body.

2. The vehicle event data recorder set capable of retaining a handset as claimed in claim 1, further comprising:
a telescopic handset retaining frame positioned at an upper side of the main body; the telescopic handset retaining frame having two supporting rods and a retaining block supported by the two supporting rods; a height of the two supporting rods being adjustable; when a handset is placed upon the handset retaining seat, the height of the retaining block is adjusted to exactly clamp the handset.

3. The vehicle event data recorder set capable of retaining a handset as claimed in claim 1, wherein the handset retaining seat extends from a lower side of the main body so that the connection of the main body and the handset retaining seat has an L shape.

4. The vehicle event data recorder set capable of retaining a handset as claimed in claim 1, wherein the main body further comprising a plurality of USB slots at a lateral side of the main body.

5. The vehicle event data recorder set capable of retaining a handset as claimed in claim 1, wherein the main body further comprising:
a GPS positioning system for getting a position of the main body; the position data is transferred to a map in a handset through the WiFi system so as to be combined to the map.

6. The vehicle event data recorder set capable of retaining a handset as claimed in claim 4, wherein
a USB handset power charger includes a charger USB plug, an electric wire and a handset USB plug; when the charger USB plug is inserted into a USB slot of the main body and the handset USB plug is connected to the handset on the handset retaining seat, the handset will be charged.

7. The vehicle event data recorder set capable of retaining a handset as claimed in claim 1, wherein the main body further includes:
a car MP3 communication unit includes a device end USB plug, an MP3 wire, and a car-end plug; the device end USB plug is connectable with the USB slot; the car-end plug of the MP3 communication unit is connected to an ignition plug of a car so that the MP3 signals are transferred to a car stereo through the car-end plug; thus the MP3 signals can be emitted from a car trumpet.

8. The vehicle event data recorder set capable of retaining a handset as claimed in claim 1, wherein the camera is located on a round cylinder which is located at a lateral side of the main body and has the same elevation as that of main body; and the round cylinder is rotatable through 180 degrees and has a fine adjusting button for adjusting a height of the camera;

9. The vehicle event data recorder set capable of retaining a handset as claimed in claim 6, wherein the electric wire of the USB handset power charger is telescopic, and thus as the handset is not placed on the handset retaining seat, it can be charged through the electric wire.

10. The vehicle event data recorder set capable of retaining a handset as claimed in claim 5, wherein the GPS positioning system is built with trace recorder for recording traces of the main body.

11. The vehicle event data recorder set capable of retaining a handset as claimed in claim 1, wherein a backside of the main body has a convex portion connected to the connecting rod; an upper side of the connecting rod has an adjusting shaft and a supporting frame; the adjusting shaft serves to adjust the orientation of the disk so that the main body can be absorbed to the windscreen; the supporting frame extends from the connecting rod to the disk for retaining the disk.

12. The vehicle event data recorder set capable of retaining a handset as claimed in claim 1, wherein the WiFi system includes a WiFi-SOS device for finding a wireless base station so to as transfer the data of SD card in the main body wirelessly to other servos.

13. The vehicle event data recorder set capable of retaining a handset as claimed in claim 12, wherein after uploading of the data, these data are removed from the SD card.

14. The vehicle event data recorder set capable of retaining a handset as claimed in claim 1, wherein the G-sensor is an independent device.

15. The vehicle event data recorder set capable of retaining a handset as claimed in claim 1, wherein the G-sensor acts even the main body is deactivated; and before and after a specific event, the G-sensor instructs the processor to record the data in the SD card to a memory.

16. The vehicle event data recorder set capable of retaining a handset as claimed in claim 15, wherein the specific event is an impact to the car having the main body.
